(19) United States
(12) Patent Application Publication
(10) Pub. No.: US 2008/0004189 A1
(43) Pub. Date: Jan. 3, 2008

(54) EFFERVESCENT BIOCIDE COMPOSITIONS FOR OILFIELD APPLICATIONS

(75) Inventors: KEVIN SMITH, HOUSTON, TX (US); LEONARD J. PERSINSKI, PITTSBURGH, PA (US); MARK WANNER, ALIQUIPPA, PA (US)

Correspondence Address: WONG, CABELLO, LUTSCH, RUTHERFORD & BRUCCULERI,;L.L.P., 20333 SH 249, SUITE 600, HOUSTON, TX, 77070, US

(73) Assignee: WEATHERFORD/LAMB, INC., HOUSTON, TX (US)

(21) Appl. No.: 11/427,541

(22) Filed: Jun. 29, 2006

(51) Int. Cl. C09K 8/00; E21B 43/00

(52) U.S. Cl. 507/129; 507/236

(57) ABSTRACT

Disclosed herein are methods and compositions for using effervescent materials to deliver biocides to fluids. Generally, the effervescent material is a solid that includes an acid and a base that react in aqueous medium to produce a gas, such as carbon dioxide. The effervescent material can be tablets, powder, flakes, and the like. The effervescent material includes one or more biocides, which are dispersed in the fluid by effervescent action that occurs when the material is added to the fluid. The methods and compositions are particularly suited for treating oil field fluids such as fracturing fluids.

### FIELD OF THE INVENTION

The invention relates to the field of oil well stimulation, drilling and recover and more specifically to biocides for treating oil field fluids such as stimulation fluids and drilling fluids.

### BACKGROUND

Many oil field operations require that fluids be introduced into a well bore. For example, drilling fluids are commonly used during drilling a well bore to lubricate the drill bit and to carry cuttings and debris to the surface. Workover and completion fluids may be introduced into the well bore during and following drilling. Hydraulic fracturing is a stimulation treatment routinely performed on oil and gas wells in low-permeability reservoirs. Specially engineered fluids are pumped at high pressure and rate into the reservoir interval to be treated, causing a vertical fracture to open. The wings of the fracture extend away from the well bore in opposing directions according to the natural stresses within the formation. Proppants, such as grains of sand of a particular size, is mixed with the treatment fluid keep the fracture open when the treatment is complete. Hydraulic fracturing creates high-conductivity communication with a large area of formation and bypasses any damage that may exist in the near-wellbore area.

Fluids used in oil field applications are often mixed and/or stored on the surface prior to being introduced into the well bore. Storage environments are often conducive to growth of micro-organisms that can cause significant problems if they are introduced into the well bore. Slime forming organisms can form biofilms that provide ideal conditions for anaerobic bacteria to grow under the surface of the slime. Anaerobic environment down hole can favor the proliferation of such anaerobic sulphate-reducing bacteria, which produce hydrogen sulfide. Produced hydrogen sulfide can lead to souring of the reservoir or can lead to the mistaken conclusion that the hydrogen sulfide is native to the reservoir itself, i.e., that the reservoir is already sour. Biomass of organisms such as algae can block and/or corrode pipes and hoses. Such bio-fouling problems are recognized in the art. Furthermore, many contaminating bio-organisms can digest components, such as polymers, that are used in the oil field fluid, thus degrading the effectiveness of the fluid.

It is known in the art to treat oil field fluids with biocides to combat the problems associated with contamination of oil field fluids by bio-organisms. For example, one or more biocides can be added to a tank where oil field fluids are being mixed and/or stored. The biocide may be in a liquid or solid (typically a powder) form.

However, problems are associated with both liquid and solid modes of delivering and biocides with oil field fluids. Liquids reagents are often inconvenient to handle on the oil patch because they spill easily. Solids formulations, on the other hand, are often difficult to disperse in the oil field fluid and require much agitation of the fluid to achieve dispersion. Many solid formulation are hygroscopic and must be handled in controlled environments, otherwise they will absorb water and clump. Solid formulations can be provided in water-soluble bags to prevent the solid from clumping prior to the formulation being introduced into the fluid, but this does not solve the problem of adequately dispersing the formulation in the fluid. Thus, there exists in the art a need for formulations of biocides useful for treating oil field fluids formulated for easy handling and dispersion in the fluid.

### SUMMARY

Disclosed herein are methods and compositions that address the deficiencies in the art pointed out above. Specifically, methods and compositions for using effervescent materials to deliver biocides to fluids are disclosed. Generally, the effervescent material is a solid that includes an acid and a base that react in aqueous medium to produce a gas, such as carbon dioxide. The effervescent material can be tablets, powder, flakes, and the like. The effervescent material includes one or more biocides, which are dispersed in the fluid by effervescent action that occurs when the material is added to the fluid. The methods and compositions are particularly suited for treating oil field fluids such as fracturing fluids. Additional aspects and advantages of the disclosed methods and compositions will be apparent to one of skill in the art in view of the present disclosure and claims.

### DETAILED DESCRIPTION

The present disclosure provides compositions and methods for the biocidal treatment of oil field fluids. Specifically, effervescent biocidal compositions for oil field applications are disclosed. The compositions generally include one or more biocidal ingredients delivered in the form of an effervescent tablet.

A familiar example of effervescence is Alka-Seltzer dissolving in water. The inventors have discovered that effervescent tablets provide a useful delivery method for delivering biocidal agents to oil field fluids because (1) they alleviate problems encountered with the current mode of choice for application of dry biocides, i.e., water soluble bags and (2) the effervescent action of the tablet dissolving in the fluid serves to disperse the biocidal agent in the fluid.

Effervescence is the reaction (typically in aqueous environment) of acids and bases to produce a gas such as carbon dioxide. Examples of suitable acids include citric, malic, tartaric, adipic, and fumaric acids. Examples of suitable bases include sodium bicarbonate, potassium bicarbonate, sodium carbonate, and potassium carbonate. Effervescent tablets can include additional components such as binders, lubricants, and fillers. Examples of additional components can include, but are not limited to, dextrose, sorbitol, xyitol, lactose, borax, sodium benzoate, polyethylene glycol, and adipic acid. Additional examples of suitable acids, bases, lubricants and the like for effervescent formulations are described in U.S. Pat. No. 6,811,793, which is incorporated by reference herein in its entirety. Additionally, the effervescent tablets disclosed here include one or more biocidal agents.

Methods of making effervescent tablets are known in the art. Generally, effervescent tablets and powders are produced in a similar manner as conventional tablets and powders, but production must occur in a low humidity environment. Effervescent granulations can be mixed in conventional blending equipment, such as ribbon, twin-cone, and V-type blenders. Traces of moisture can result in erratic granulation results. Formulations can go through a drying process prior to tabletting. A typical effervescent formulation will contain less than about 0.5% moisture. Temperature and humidity in the production area typically should be about 65 to about 75 F and relative humidity of about 10 percent or less.

The effervescent tablets disclosed herein can be used to deliver essentially any biocides used for oil field applications, including but not limited to, 2,2,-dibormo-3-nitrilo-propionamide (DBNPA), 1,2-dibromo-2,4-dicyanobutane, 2-bromo-2-nitropropane-1,3-diol, 4,4-dimethyloxazolidine, 1-(3-chloroallyl)-3,5,7-triaza-1-azoniaadamantane chloride, tris(hydroxymethyl)nitromethane, alkyl dimethyl benzyl ammonium chloride, isothiazolone, carbamates, metronidazole, and glutaraldehyde. Additional biocides are known in the art, for example, the biocides listed in U.S. Pat. No. 4,552,591, the entire contents of which are incorporated herein by reference. Furthermore, commercially available biocide formulations can be reformulated as effervescent formulations for delivery according to the present disclosure. Examples of suitable formulations include formulations such as the BIO-CLEAR formulations e.g., BIO-CLEAR 550, BIO-CLEAR 1050, BIO-CLEAR 750, and BIO-CLEAR 1000, available from Clearwater, Inc., Houston, Tex.

Effervescent tablets can contain one biocidal agent or can contain more than one biocidal agent. The amount of biocidal agent per tablet can be typically between about 10 weight percent and about 90 weight percent, although about 20 weight percent to about 80 weight percent is more typical. For example, a effervescent biocidal tablet might contain about 50 percent biocide. A tablet containing two different biocides might contain 25 percent of one biocide, 25 percent of another biocide, 20 percent acid, 20 percent base, and 10 percent flow improver, filler, binder, etc. As an example, an effervescent biocidal tablet might contain about 5 to about 35 weight percent of 2,2,-dibormo-3-nitrilo-propionamide and about 5 to about 35 weight percent of percent of 1,2-dibromo-2,4-dicyanobutane. As a more specific example, an exemplary effervescent biocidal tablet contains about 25 percent DBNPA, about 25 percent 1,2-dibromo-2,4-dicyanobutane, about 20 percent sodium bicarbonate, about 20 percent citric acid, and about 10 percent boric acid.

Given an effervescent biocidal formulation containing a given concentration of biocide, it is within the ability of one of skill in the art to decide how much effervescent biocidal formulation to use to treat a given amount of oil field fluid. Oil field fluids include any fluid used in oil field applications, including but not limited to drilling fluid, completion fluid, workover fluid, fracturing fluid packer fluid, injection water, produced water that is to be reinjected, and the like. Such fluids are typically aqueous. The fluids are treated by adding a sufficient amount of effervescent biocidal tablet to the fluid to achieve the desired amount of biocidal agent in the fluid. As an example, the desired amount of biocidal agent might be about 10 ppm to about 50,000 ppm, and more typically about 100 ppm to about 2,000 ppm for treating fracturing fluid.

Generally, the oil field fluid is treated by adding an adequate amount of effervescent tablets to a tank or other container containing the oil field fluid and allowing the tablets to effervesce, thus dispersing the biocidal agent in the oil field fluid. The oil field fluid can then be used for its intended purpose or stored for a time prior to use.

While the disclosed effervescent biocidal materials have primarily been discussed herein with regard to tablets, any form of effervescent material can be used to deliver biocides according to the disclosed methods. For example, effervescent powder blends, flakes, particles, sachets, and the like can be used. The effervescent biocidal composition can be delivered to a container containing oil field fluid by any means, for example by simply dumping the biocidal composition into the container using a shovel, scoop, hopper, or by hand. Alternatively, dissolvable packages of effervescent biocidal material can be added to such containers.

While the disclosed effervescent biocidal materials have primarily been discussed herein with regard to treating oil field fluids, the effervescent biocidal materials can be used to treat any fluid under circumstances where control of contamination and proliferation of bio-organisms is needed. For example, the disclosed compositions and methods can be used to treat water in cooling towers, evaporation ponds, waste water, and the like.

It should be understood that the inventive concepts disclosed herein are capable of many modifications. To the extent such modifications fall within the scope of the appended claims and their equivalents, they are intended to be covered by this patent.

What is claimed is:

1. A composition for treating a fluid, the composition comprising an effervescent material and one or more biocides.

2. The composition of claim 1, wherein the one or more biocides are selected from the group consisting of 2,2,-dibormo-3-nitrilo-propionamide (DBNPA), 1,2-dibromo-2,4-dicyanobutane, 2-bromo-2-nitropropane-1,3-diol, 4,4-dimethyloxazolidine, 1-(3-chloroallyl)-3,5,7-triaza-1-azoniaadamantane chloride, tris(hydroxymethyl)nitromethane, alkyl dimethyl benzyl ammonium chloride, isothiazolone, carbamates, metronidazole, tetrakis hydroxymethyl phosphonium sulfate, cocodiamine acetate, and glutaraldehyde.

3. The composition of claim 1, wherein the concentration of the one or more biocides is about 20 weight percent to about 80 weight percent of the composition.

4. The composition of claim 1, wherein the one or more biocides comprise two biocides.

5. The composition of claim 4, wherein in the two biocides are 2,2,-dibormo-3-nitrilo-propionamide and 1,2-dibromo-2,4-dicyanobutane.

6. The composition of claim 5, wherein the composition comprises about 5 to about 35 weight percent of 2,2,-dibormo-3-nitrilo-propionamide and about 5 to about 35 weight percent of percent of 1,2-dibromo-2,4-dicyanobutane.

7. The composition of claim 1, wherein the composition is in the form of a tablet, powder, flake, particle, or sachet.

8. A method of treating a fluid, comprising adding to the fluid a composition comprising an effervescent material and one or more biocides.

9. The method of claim 8, wherein the fluid is an oil field fluid.

10. The method of claim 9, wherein the fluid is a fracturing fluid.

11. The method of claim 8, wherein the one or more biocides are selected from the group consisting of 2,2,-dibormo-3-nitrilo-propionamide (DBNPA), 1,2-dibromo-2,4-dicyanobutane, 2-bromo-2-nitropropane-1,3-diol, 4,4-dimethyloxazolidine, 1-(3-chloroallyl)-3,5,7-triaza-1-azoniaadamantane chloride, tris(hydroxymethyl)nitromethane, alkyl dimethyl benzyl ammonium chloride, isothiazolone, carbamates, metronidazole, tetrakis hydroxymethyl phosphonium sulfate, cocodiamine acetate, and glutaraldehyde.

12. The method of claim 8, wherein the concentration of the one or more biocides is about 20 weight percent to about 80 weight percent of the composition.

13. The method of claim 11, wherein the composition comprises about 5 to about 35 weight percent of 2,2,-dibormo-3-nitrilo-propionamide and about 5 to about 35 weight percent of percent of 1,2-dibromo-2,4-dicyanobutane.

14. The method of claim 8, wherein the composition is in the form of a tablet, powder, flake, particle, or sachet.

15. The method of claim 8, wherein adding comprises adding an amount of composition such that the concentration of biocide in the fluid is about 10 to about 50,000 ppm.

16. The method of claim 8, wherein the composition is contained within a dissolvable package that is added to the fluid.

17. The method of claim 8, wherein the one or more biocides are dispersed in the fluid by effervescent action.
